(19) United States
(12) Patent Application Publication
(10) Pub. No.: US 2024/0227759 A1
(43) Pub. Date: Jul. 11, 2024

(54) Method and Control Arrangement for Controlling a Speed of a Vehicle When Approaching and/or Travelling a Downhill Road Section

(71) Applicant: Scania CV AB, Södertälje (SE)

(72) Inventors: Mikael Alenius, Segeltorp (SE); Oliver Somos, Hägersten (SE); Frank Mohr, Värmdö (SE); David Karlsson, Linghem (SE)

(21) Appl. No.: 18/392,367

(22) Filed: Dec. 21, 2023

(30) Foreign Application Priority Data
Jan. 11, 2023 (SE) 2350014-3

(51) Int. Cl. B60T 8/58; B60T 7/22; B60T 8/171; B60T 8/172

(52) U.S. Cl. CPC B60T 8/58; B60T 7/22; B60T 8/171; B60T 8/172; B60T 2201/022; B60T 2201/04; B60T 2210/20; B60T 2210/32; B60T 2250/04

(57) ABSTRACT

Disclosed is a method performed by a control arrangement for controlling a speed of a first vehicle comprising a plurality of brake systems configured to provide brake power for braking the vehicle. The method comprises, when a downhill road section is to be travelled, and when a second vehicle is travelling in front of the first vehicle predicting a plurality of minimum distances corresponding to different brake powers to be applied by at least one of the plurality of brake systems when approaching and/or travelling the downhill road section, each minimum distance constituting a resulting minimum distance to the second vehicle. The method further comprises applying, by at least one of the plurality of brake systems, a brake power corresponding to the brake power to be applied to obtain the minimum distance of the plurality of minimum distances such that at least a predetermined minimum distance to the second vehicle is maintained when approaching and/or travelling the downhill road section.

### TECHNICAL FIELD

The invention relates to a method and a control arrangement for controlling a speed of a vehicle. More specifically the invention relates to controlling the vehicle speed when the vehicle is approaching and/or travelling a downhill road section and when at least a predetermined minimum distance to a second vehicle is to be maintained. The invention also relates to a computer program, a computer-readable medium and a vehicle comprising such a control arrangement.

### BACKGROUND

The following background description constitutes a description of the background to the invention, which does not, however, necessarily have to constitute prior art.

Modern vehicles, including heavy motor vehicles, such as trucks and busses, are today commonly provided with one or more speed control systems controlling the speed of the vehicle. Many recent speed control systems are configured to provide the vehicle operator with enhanced comfort while increasing travel safety and energy economy. A vehicle may, for example, be equipped with an adaptive cruise control ACC for controlling the vehicle speed relative to surrounding traffic conditions. The speed of the vehicle may, for example, be adjusted to maintain a safe distance from a vehicle ahead and in that way to follow the traffic flow. Such a safe distance may for example be a distance requested by the vehicle operator.

When travelling on downhill gradients, the vehicle speed is often adjusted by controlling one or more auxiliary brake systems in the vehicle in order to apply a required brake torque. This decreases the need of using service brakes, such as wheel brakes, which may become overheated and less efficient when excessively used. Examples of such auxiliary brake systems include, but is not limited to, various engine brake systems, such as compression release brake or an exhaust brake, and a retarder brake system. Another example of an auxiliary brake system that may be used for this purpose is a regenerative brake system.

### SUMMARY

It is an object of embodiments of the invention to further improve the functionality of speed control.

Thus, it is an object to provide a solution in a vehicle that enables an automatic speed control to use different brake systems in an efficient way, especially in situations when the vehicle is approaching and/or travelling a downhill road section and is following another vehicle.

According to a first aspect of the invention, aforementioned and further objectives are achieved through a method performed by a control arrangement for controlling a speed of a first vehicle, the first vehicle comprising a plurality of brake systems configured to provide brake power for braking the vehicle, the method comprising, when a downhill road section is to be travelled, and when a second vehicle is travelling in front of the first vehicle:
predicting a plurality of minimum distances corresponding to different brake powers to be applied by at least one of the plurality of brake systems when approaching and/or travelling the downhill road section, each minimum distance constituting a resulting minimum distance to the second vehicle, and
applying, by at least one of the plurality of brake systems, a brake power corresponding to the brake power to be applied to obtain the minimum distance of the plurality of minimum distances such that at least a predetermined minimum distance to the second vehicle is maintained when approaching and/or travelling the downhill road section.

In the context of conventional inter-vehicle distance maintaining speed controllers such as adaptive cruise controls ACC, the predetermined minimum distance refers to a minimum maintained distance to the vehicle in front. The present invention improves the possibility for maintaining the minimum distance to the second vehicle at a distance equal to or higher than the predetermined minimum distance in an approaching downhill road section. This is achieved by initiating braking at an earlier stage than when the predetermined distance would have been reached by means of conventional inter-vehicle distance maintaining speed controllers. The method may thus be described as resulting in a pre-braking of the vehicle where the speed of the vehicle is reduced prior a downhill road section. Due to such pre-braking, a peak brake power applied when approaching and travelling a downhill road section is reduced compared to conventional methods and the total brake energy required to maintain the predetermined minimum distance is distributed over a longer time interval. This results in a decreased wear on the vehicle's brakes and decreases risk of brake overheating. Moreover, in case the vehicle is an electric vehicle, and the brake power is applied by regenerative brakes, the risk of overheating the vehicle's electric machine as well the wear on the electrical machine is reduced. A reduced peak brake power when approaching and/or travelling a downhill road section may furthermore result in an increased efficiency of the regenerative brake system since braking at high powers, when the regeneration is generally lower, is avoided. Furthermore, early braking of the vehicle in a downhill road section may increase the feeling of safety for the vehicle operator. Another advantage of the pre-braking achieved when the method of the invention is applied is increased traveling safety. Since the speed of the vehicle is decreased earlier compared to conventional methods, the risk of collision with the vehicle in front is reduced also if the vehicle in front is driving more slowly than expected or estimated.

The method according to the invention relies on simulations of a plurality of minimum distances, where the simulations may be performed in parallel when approaching a downhill road section under the condition that at least the predetermined minimum distance to a vehicle in front is to be maintained in the downhill road section. The simulated plurality of minimum distances corresponds to distances that would be obtained if different brake powers were applied by at least one of the plurality of brake systems when approaching and/or travelling the downhill road section. Each applied brake power results in a minimum distance to the second vehicle. Based on the results of said simulations, the vehicle is braked by applying a brake power that corresponds to a minimum distance that according to the simulations fulfils the conditions of being equal or higher than the predetermined minimum distance. According to the invention, there is no need to determine an appropriate time for applying a brake power. This is because the method simply determines whether it is appropriate to apply a brake power at the current point in time, and if so, applying the brake power and thus ensuring that at least the predetermined minimum distance to the second vehicle is maintained when approaching and/or travelling the downhill road section. Hence, optimized braking efficiency and power efficient braking may be obtained in a timely manner.

The present invention may be particularly advantageous in case the vehicle comprises brake systems with a relatively weak maximum brake power, or brake systems, such as a retarder, which may rapidly get overheated, and which are only able to deliver a maximum brake power during a relatively short time. Such brake systems may not be able to deliver sufficient brake power to maintain the required distance to a vehicle in front. In such situations, additional brake power by means of a friction brake system may be required which may potentially lead to overheating of the friction brakes and less efficient braking. Reducing use of friction brakes, especially in heavy braking situations where the brake power is applied consistently and/or frequently on long downhill grades increase driving safety since the likelihood of overheating of the friction brakes in reduced. Overheating of friction brakes may potentially lead to brake fading, loss of brake power and even lead to brake damage. In addition, extended use of auxiliary brake systems will extend the life of the friction brakes, reducing cost and frequency of maintenance. According to the invention, the brake power may be applied by means of more than one brake system, which enables efficient utilization of, and reduced wear of the vehicle brakes. Moreover, the invention reduces the need of gear downshifts in the downhill road section resulting in a decreased noise level in the vehicle cabin and thus increased operator comfort.

Moreover, since the brake power is applied based on simulations of driving conditions in an approaching road section, the brake power required when approaching and/or driving in the downhill road section will be estimated in advance. The brake energy required in the forthcoming road section may thus be distributed over a longer time compared to conventional solutions. Thereby, the applied peak brake power may be reduced which reduces the wear on the components of the one or more brake systems and reduces the risk of wear, overheating and failure of brakes.

In an embodiment of the invention, the applied brake power corresponds to the brake power to be applied to obtain the minimum distance exceeding the predetermined minimum distance.

Thus, the minimum distance to a vehicle in front maintained when approaching and/or travelling the downhill road section is longer compared to the otherwise maintained predetermined minimum distance. This means that the braking distance, i.e., the distance required to reduce the speed of a vehicle, relative the vehicle in front is extended. Generally a braking distance increases in downhill slopes compared to flat roads. A vehicle travelling in a downhill road section must be able to efficiently brake when required, such as, for example, when the vehicle in front reduces its speed. Thus, increasing the vehicle's braking distance relative the vehicle in front enhances the possibility of efficient braking when needed and mitigates the risk of collision with the vehicle in front. This may be especially important in cases when the trailing vehicle, i.e., the first vehicle in this disclosure, is a heavy vehicle, such as a truck, and where the vehicle in front, i.e., the second vehicle in this disclosure, is a less heavy vehicle, such as a passenger car. The braking distance of the truck is generally longer than that of the less heavy vehicle and more affected by a downhill road section. Hereby, the safety when travelling in downhills is increased and the risk of collisions is mitigated. Moreover, the need of using the friction brake system, such as wheel brakes is eliminated or at least reduced. Thus, the risk of wear, overheating and failure of frictions brakes in the vehicle is reduced.

In an embodiment of the invention, the applied brake power corresponds to the brake power to be applied to obtain the minimum distance being within a predetermined distance interval, the predetermined distance interval being a distance interval of distances exceeding the predetermined minimum distance.

By controlling the speed of the vehicle such that the minimum distance to the vehicle in front is kept within a predetermined distance interval, the minimum distance to the vehicle in front is increased compared to when the predetermined minimum distance is maintained, which has the advantages as described above. At the same time, a too long minimum distance to the vehicle in front is avoided. A too long minimum distance may cause irritation to the vehicle operator since it may increase the risk of other vehicles cutting in between the vehicle and the vehicle in front which will increase the need of braking and further reduce the speed of the vehicle. Furthermore, a too low vehicle speed may increase the duration for the vehicle to travel a designated travel route.

In an embodiment of the invention, the predetermined distance interval is selected by an operator of the first vehicle.

Hereby, the vehicle operator may adapt the distance to current conditions and to his preferences. In an embodiment of the invention, each minimum distance corresponds to a brake power to be applied when approaching and/or travelling the downhill road section by one or more auxiliary brake systems.

Thus, maintaining at least the predetermined minimum distance to the second vehicle when approaching and/or travelling the downhill road section is achieved by at least one or more auxiliary brake systems. In that way, the use of friction brakes such as wheel brakes is reduced.

In an embodiment of the invention, the one or more auxiliary brake systems are capable of applying a brake power at a plurality of brake power levels and wherein the one or more auxiliary brake systems being utilized to apply the brake power are applied at one of a plurality of brake power levels.

Hereby, different combination of brake systems may be applied, and a suitable choice of auxiliary brake systems may be made.

In an embodiment of the invention, the method comprises, when none of the plurality of minimum distances equals or exceeds the predetermined minimum distance:
applying, by the one or more auxiliary brake systems, a brake power corresponding to the highest brake power representing a minimum distance of the plurality of minimum distances.

Thus, in heavy braking situations, the vehicle speed is reduced by using a maximum available brake power by means of one or more auxiliary brake systems thereby reducing the use of friction brakes. This further increases driving safety as well as the wear on the vehicle's brakes and the risk of brake overheating

In an embodiment of the invention, the brake power being applied is selected at least partly based on at least one of:
a predetermined priority of the plurality of brake systems,
the magnitude of a brake power required for braking the first vehicle when approaching and/or travelling the downhill road section,
a duration of the application of at least one of the plurality of brake systems to be engaged when approaching and/or travelling the downhill road section to produce the brake power required for braking the first vehicle,
the power level of at least one of the plurality of brake systems to be engaged when approaching and/or travelling the downhill road section to produce the brake power required for braking the first vehicle, and/or
an efficiency of at least one of the plurality of brake systems to be engaged when approaching and/or travelling the downhill road section to produce the brake power required for braking the first vehicle.

In this way, the brake power may be applied by one or more brake systems determined as most suitable when approaching and/or travelling the downhill road section based on parameters like braking efficiency, power consumption/generation, wear, drivability and/or driver comfort. In short, different brake systems may be associated with a predetermined priority depending on the driving situation, vehicle type and choice of prioritized behavior. The applied brake power may thus be selected such that the conditions of a minimum distance being equal or higher than the predetermined minimum distance and at the same time fulfilling the priority conditions of the different brake systems. Further, each of the different brake systems may be associated with different magnitude of brake power, which may or may not meet the magnitude of a brake power required for braking the first vehicle when approaching and/or travelling the downhill road section. Further, the duration of the application of a brake system or brake systems may be a factor to take into calculation when determining the most suitable brake system(s) to be applied, as well as the efficiency of such (a) brake system(s). Hereby, the vehicle's braking characteristics may be optimized.

In an embodiment of the invention, the method further comprises:
repeatedly predicting the plurality of minimum distances when approaching and/or travelling the downhill road section, each prediction resulting in a plurality of updated minimum distances, and based on the repeated predictions,
adjusting the applied brake power to correspond to the brake power to be applied to obtain the updated minimum distance of the plurality of updated minimum distances.

By adjusting the applied brake power to correspond to an updated minimum distance obtained by repeated prediction when approaching and/or travelling the downhill road section the applied brake power may be dynamically optimized for the entire downhill road section.

In an embodiment of the invention, the method further comprises when the first vehicle approaches the end of the downhill road section:
reducing the applied brake power to reduce the distance to the second vehicle to a reduced distance, the reduced distance at least corresponding to the predetermined minimum distance.

The applied brake power may for example reduced such that no brake power is applied in the downhill road section. By reducing the applied brake power in the end of the downhill road section, the speed of the vehicle is increased due to gravity force acting of the vehicle in the downhill road section and the vehicle's mass thereby reducing the distance to the vehicle in front to the predetermined minimum distance or even temporarily to a distance lower that the predetermined minimum distance. This is especially efficient when the minimum distance to the section vehicle maintained in the downhill road section exceeds the predetermined minimum distance and the vehicle speed is increased in the end of the downhill road section such that brake losses are minimized which may be obtained when no brake power is applied and the vehicle is in neutral or when the clutch is open. The increase of vehicle speed results in the vehicle leaving the downhill road section with an increased kinetic energy which may be utilized in the propulsion of the vehicle following the downhill road section. Hereby, increased energy efficiency is obtained.

According to a second aspect, the invention relates to a control arrangement for controlling a speed of a first vehicle, the first vehicle comprising a plurality of brake systems configured to provide brake power for braking the vehicle, the control arrangement being configured to, when a downhill road section is to be travelled, and when a second vehicle is travelling in front of the first vehicle:
predict a plurality of minimum distances corresponding to different brake powers to be applied by at least one of the plurality of brake systems when approaching and/or travelling the downhill road section, each minimum distance constituting a resulting minimum distance to the second vehicle, and
apply, by at least one of the plurality of brake systems, a brake power corresponding to the brake power to be applied to obtain the minimum distance of the plurality of minimum distances such that at least the predetermined minimum distance to the second vehicle is maintained when approaching and/or travelling the downhill road section.

According to a third aspect of the invention, aforementioned and further objectives are achieved through a vehicle comprising a control arrangement according to the second aspect.

According to a fourth aspect, the invention relates to a computer program comprising instructions which, when the program is executed by a computer, cause the computer to carry out the method according to the first aspect.

According to a fifth aspect, the invention relates to a computer-readable medium comprising instructions which, when executed by a computer, cause the computer to carry out the method according to the first aspect.

### BRIEF DESCRIPTION OF THE DRAWINGS

Embodiments of the invention will be illustrated in more detail below, along with the enclosed drawings, where similar references are used for similar parts, and where:

FIG. 1 illustrates a vehicle in which embodiments of the invention may be implemented.

FIG. 2 shows a method for controlling the speed of a vehicle according to embodiments of the invention.

FIG. 3 illustrates a non-limiting example of a driving scenario in which one or more embodiments of the invention may be implemented.

FIG. 4 illustrates a flow chart of a method for controlling a speed of a first vehicle according to further embodiments of the invention.

FIG. 5 illustrates an example of simulated distance profile for four different brake powers to be applied when approaching and/or travelling a downhill road section.

FIG. 6 illustrates another example of simulated distance profile for four different brake powers to be applied when approaching and/or travelling a downhill road section.

FIG. 7 illustrates a control arrangement of the vehicle of FIG. 1 according to embodiments of the invention.

### DETAILED DESCRIPTION

According to conventional solutions, a speed of a vehicle may be automatically controlled to maintain a requested safe distance to a vehicle in front. Typically, such distance is selected by the vehicle operator and comprises a predetermined minimum distance D_{pred_min} which is a minimum inter-vehicle distance that the vehicle is allowed to keep. Examples of such automatic speed controllers configured to maintain a requested distance are adaptive cruise control ACC. Such speed controllers use information from a distance sensor that monitors the distance to a vehicle in front and adjusts the speed of the vehicle such that the requested distance to the vehicle in front is maintained or such that the distance to the vehicle in front does not fall below the predetermined minimum distance. When traveling downhill, the speed of the vehicle increases if no brakes are applied due to the force of gravity. Maintaining a set-distance to a vehicle in front is thus obtained by applying a brake force reducing the speed of the vehicle. Such brake force may be applied by means of one or more brake systems in the vehicle. One example of brake systems is friction brake system, such as wheel brakes. A disadvantage of using friction brake system, such as wheel brakes, is that the brake pads of the wheel brakes are subjected to wear which is associated with a cost as the brake pads will eventually have to be replaced when they are worn out. Consequently, the use of wheel brakes should be minimised if auxiliary brakes are suitable to use instead as auxiliary brakes are not associated with cost in the same manner as wheel brakes. Further, should the wheel brakes be overheated due to excessive use, their braking effect may become severely reduced which may be disastrous. The heavier the vehicle the more heat is created. In situations of hard braking this heat can cause the brakes to fade or lose their braking power. This can occur if the brakes are used frequently or consistently in downhill grades. In extreme braking situations the brakes can also be damaged.

Typically, braking in downhill grades are therefore preferably done by means of one or more auxiliary brake system as a supplement to friction brakes. Auxiliary brakes increase the brake power and reduce the likelihood that the friction brakes will overheat. Examples of auxiliary brakes include exhaust brakes, compression brakes, retarder and, in case of the vehicle being an electric vehicle regenerative brakes.

However, in some situations, the applied auxiliary brake system may not be able to deliver a sufficient brake power for maintaining the requested distance. This may be the case when travelling on downhill gradients especially on steep and/or long downhill gradients for heavy vehicles or in case sudden high brake power is required. In such cases, brake power is provided by means of friction brakes which may increase the risk of potentially dangerous situations as described above.

Thus, an improved method to control the speed of a vehicle approaching and/or travelling a downhill road section where the vehicle, herein referred to as the first vehicle, is configured to maintain a distance to a second vehicle in front is required to overcome the problems of conventional solutions.

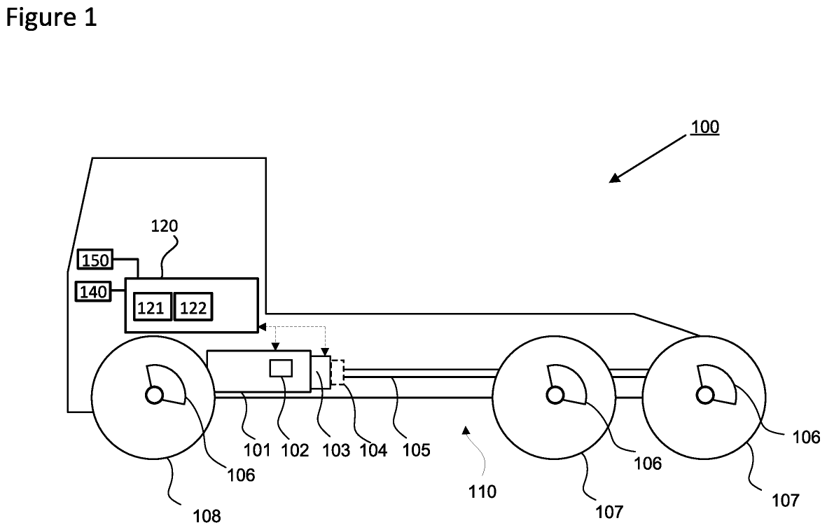

FIG. 1 schematically shows a side view of an exemplary vehicle 100, here illustrated as a truck. It should be noted that only the units/devices/entities of the vehicle 100 useful for understanding the invention are illustrated in FIG. 1. The vehicle 100 in FIG. 1 comprises a powertrain 110 comprising at least one propulsion unit 101. The propulsion unit 101 may include a combustion engine which, in a customary fashion, may be connected to a gearbox 103. The gearbox may be connected to the driving wheels 107 of the vehicle 100 via an output shaft 105 of the gearbox 103. In addition to the propulsion unit 101 comprising a combustion engine, the vehicle 100 may include one or more electrical machines for driving drive wheels 107 of the vehicle 100 and may thus for example be a so-called hybrid vehicle.

In another example, the propulsion unit 101 may include only electrical machines for driving the drive wheels 107, whereby the vehicle 100 may be a pure electrical vehicle. The one or more electrical machines may be arranged essentially anywhere along the driveline 110, as long as torque is provided to the driving wheels 107 as is understood by a skilled person. It should be understood that the vehicle 100 may be arranged in any known way, for example without the gearbox 103 illustrated in FIG. 1 without limiting the scope of the invention.

The vehicle may comprise a friction brake system 106, such as e.g., wheel brakes arranged at the wheels of the vehicle 107, 108. The vehicle may further comprise as least one auxiliary brake system 102 with a brake power that is dependent on the speed of the propulsion unit 101 and/or an engaged gear of the gearbox 103. Example of such auxiliary brake systems 102 is engine brake system which may relate to a brake system which utilizes the propulsion unit 101 of the vehicle 100 to provide a brake power and thereby slowing down the vehicle 100. Thus, the engine brake system may, for example, include a compression release brake system and an exhaust brake system in case the vehicle comprises a combustion engine. The vehicle may optionally comprise an auxiliary brake system 104 with a brake power independent of the speed of the propulsion unit 101, such as a retarder. Such a retarder 104 may, for example, be connected to an output shaft of the gearbox 103 as illustrated in FIG. 1. Alternatively, the retarder 104 may be connected to a shaft of the propulsion unit 101.

Furthermore, the engine brake system may comprise a regenerative brake system in case the vehicle 100 comprises an electric machine. In a regenerative brake system, the electric machine is operated as a generator whereby kinetic energy of the vehicle 100 may be converted to electrical energy and thereby slow down the speed of the vehicle.

The powertrain 110 and its components may be controlled by the vehicle's control system(s) via at least one control arrangement 120 in which the disclosed invention may be implemented. The at least one control arrangement 120 may be, for example, responsible for automatically controlling the speed of the vehicle 100.

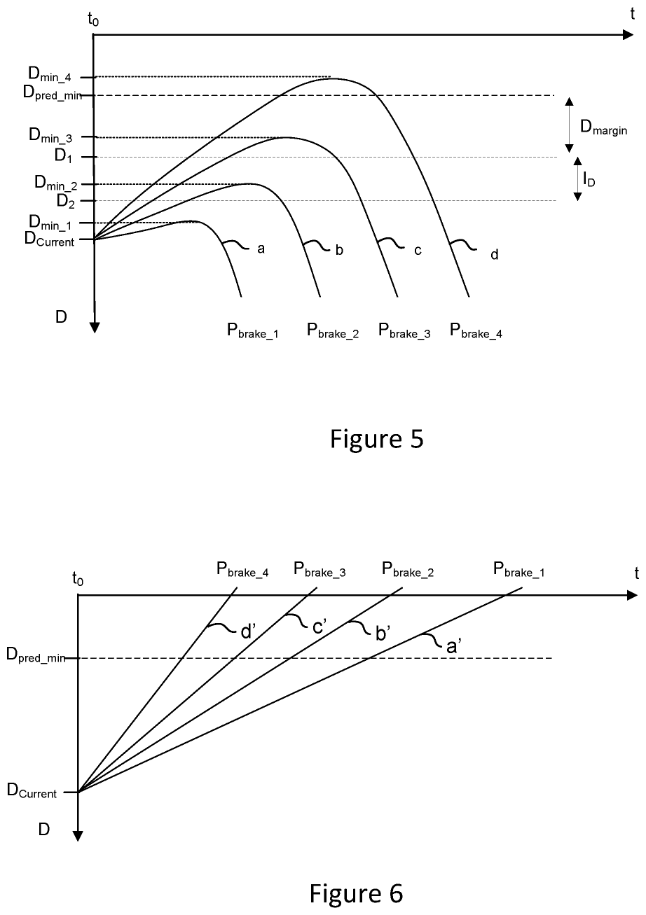

The control arrangement 120 may be distributed on several control units configured to control different parts of the vehicle 100. The control arrangement 120 may e.g. include a minimum distance predicting unit 121, and a brake power applying unit 122 arranged for performing the method steps of the disclosed invention as is explained further. The control arrangement 120 will be described in further detail in FIG. 7.

The vehicle 100 may further include at least one sensor 140, e.g. a camera located at suitable positions within the vehicle 100.

Further, the vehicle 100 may comprise a positioning system/unit 150. The positioning unit 150 may be based on a satellite navigation system such as the Navigation Signal Timing and Ranging Navstar, Global Positioning System GPS, Differential GPS DGPS, Galileo, GLONASS, or the like. Thus, the positioning unit may comprise a GPS receiver.

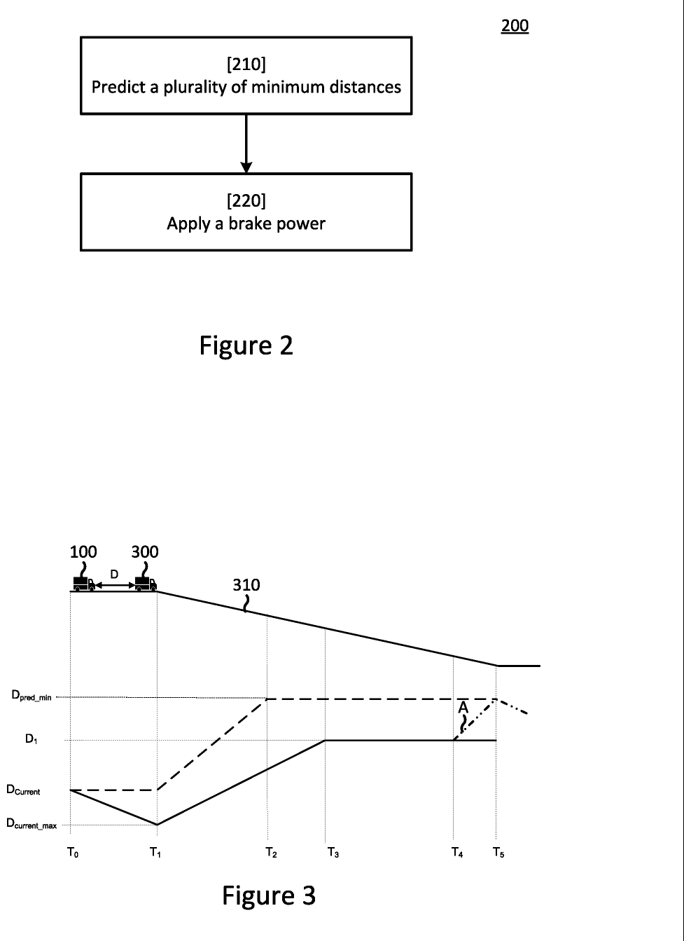

The proposed solution will now be described with reference to FIG. 2 which shows a flow chart of a method 200 performed by a control arrangement, such as the control arrangement 120 illustrated in FIG. 1 for controlling a speed of a first vehicle, such as the vehicle 100 illustrated in FIG. 1.

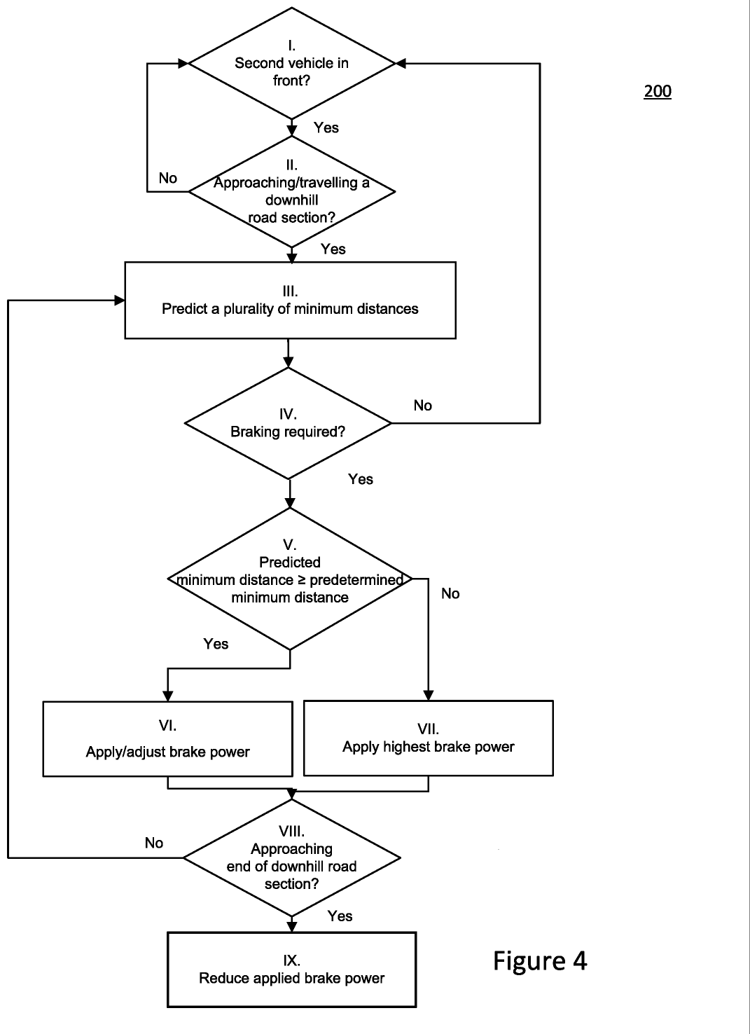

The method 200 comprises steps 210-220 and is performed when the first vehicle 100 is to travel a downhill road section and when a second vehicle is travelling in front of the first vehicle. One example of a driving scenario in which embodiments of the invention may be implemented in shown in the upper part of FIG. 3. The driving scenario comprises a first vehicle 100 approaching a downhill road section 310. A second vehicle 300 is driving in front of the first vehicle 100 at a distance D. A downhill road section may here be understood as a road section where the first vehicle 100 is accelerated by gravity. FIG. 3 illustrates a conventional method as well as the method according to the invention of automatic control of the vehicle speed by maintaining a predetermined distance to a vehicle in front, i.e., the second vehicle 300.

According to conventional methods, illustrated by the dashed line in FIG. 3, the distance D to a second vehicle in front 300 is compared to the predetermined minimum distance D_{pred_min}. A first vehicle 100 approaches here a downhill road section between the time instance T₀ and T₁. The conventional method, illustrated by the dashed line in FIG. 3, automatically maintains the speed of the first vehicle 100 such that a current distance D_{current} to the second vehicle 300 is maintained. At the time instance T₁ the first vehicle 100 enters the downhill road section which results in a speed increase and decreased distance D to the second vehicle 300. When the predetermined minimum distance D_{pred_min} is reached at the time instance T₂, a brake power is applied in the remaining part of the downhill road section 310 i.e. between the time instance T₂ and T₅ to maintain the predetermined minimum distance D_{pred_min}.

The present invention, on the other hand, comprises predicting in step 210 in FIG. 2, a plurality of minimum distances D_{min_1}, D_{min_2}, . . . , D_{min_n} corresponding to different brake powers P_{brake_1}, P_{brake_2}, . . . , P_{brake_n} that can be applied by at least one of the plurality of brake systems when approaching and/or travelling the downhill road section 310, each minimum distance constituting a resulting minimum distance to the second vehicle 300.

The present invention further comprises in step 220 in FIG. 2, applying a brake power by at least one of the plurality of brake systems. The brake power corresponds to the brake power to be applied to obtain the minimum distance of the plurality of minimum distances D_{min_1} D_{min_2}, . . . , D_{min_n} such that at least a predetermined minimum distance D_{pred_min} to the second vehicle 300 is maintained when approaching and/or travelling the downhill road section 310.

Thus, the present invention predicts how the minimum distance to a second vehicle 300 would vary if different brake powers P_{brake_1}, P_{brake_2}, . . . , P_{brake_n} would currently be applied in the approaching downhill road section 310. Based on this prediction, the method applies a suitable brake power, based on the predictions, when approaching and/or travelling the downhill road section 310 such that at least the predetermined minimum distance D_{pred_min} to the second vehicle 300 is maintained. According to the invention, the brake power may therefore be activated at an earlier point, i.e. already when the first vehicle 100 approaches the downhill road section between the time instance T₀ and T₁ resulting in a temporary increase of the distance D as illustrated by the solid line in FIG. 3 to a level depicted as D_{current}_max. Thus, as previously described, the method may be described as resulting in a pre-braking of the first vehicle 100. Due to the applied brake power, the distance D may decrease more slowly, compared to the conventional solutions as depicted in FIG. 3 between time instance T₁ and T₃ until reaching a distance D₁. In the scenario illustrated in FIG. 3, the distance D₁ is illustrated as exceeding the predetermined minimum distance D_{pred_min}. However, it is to be understood that, according to the invention, the distance D₁ may be any distance equal to or exceeding the predetermined minimum distance D_{pred_min}. In an embodiment, when the distance D₁ has been reached, it may be maintained by the present invention until the end of the downhill road section 310 has been reached at the time instance T₅ in FIG. 3 as will be explained further on. Maintaining the distance D₁ is to be understood as the present invention allows maintaining a distance equal to or larger than the predetermined minimum distance D_{pred_min} and thereby, as previously explained, increases the travelling safety of the vehicle 100 by increasing the vehicles braking distance and enables energy efficient operation of the vehicle 100.

The plurality of minimum distances D_{min_1}, D_{min_2}, . . . , D_{min_n} predicted in step 210 in FIG. 2 may be based on the condition that braking is currently to be requested in the first vehicle 100. The plurality of minimum distances D_{min_1}, D_{min_2}, . . . , D_{min_n} may be predicted by determining a plurality of distance profiles, i.e., distance variations between the first vehicle 100 and the second vehicle 300 if different brake powers P_{brake_1}, P_{brake_2}, . . . , P_{brake_n} would have been applied in the downhill road section 310.

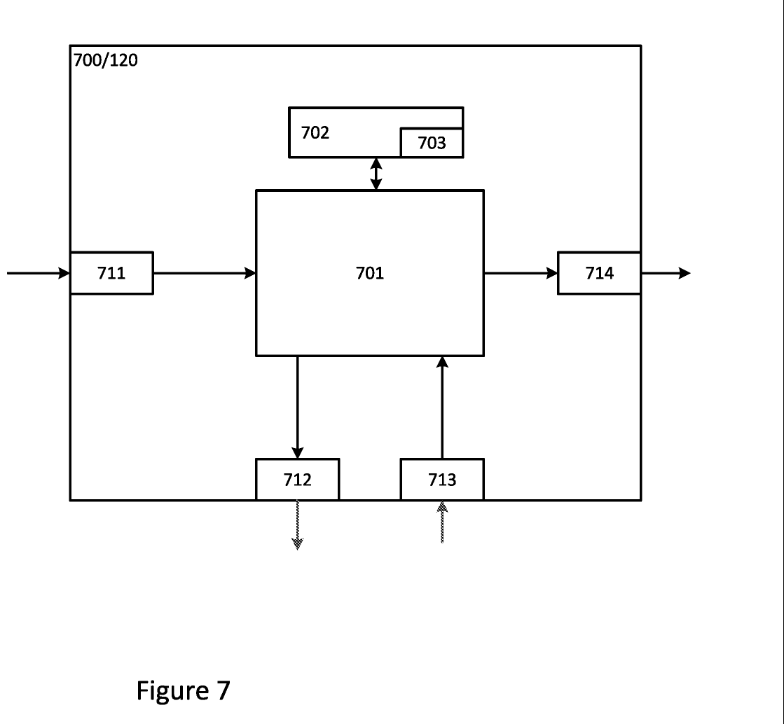

Each minimum distance is predicted for a brake power applied in the approaching road section as will be explained with reference to FIG. 5.

FIG. 5 schematically illustrates an example of a result of predicting a plurality of minimum distances according to an embodiment of the method 200. FIG. 5 shows four distance profiles a, b, c and d illustrating a change over time of the distances between the first vehicle 100 and the second vehicle 300 for an upcoming road section for four different brake powers P_{brake_1}, P_{brake_2}, P_{brake_3}, P_{brake_4} if braking would currently be requested. Thus, four different predictions of profiles for the first vehicle 100 of a distance to the second vehicle 300 over time t has been made in parallel and are thus valid for the same upcoming road section.

The parallel predictions are performed for a current request for braking at t₀ and based on the fact that the current distance at the time instance t₀ is D_{current}. As shown in FIG. 5, each distance profile comprises a minimum distance to the second vehicle D_{min_1}, D_{min_2}, D_{min_3}, D_{min_4}.

The prediction of the distance profiles may typically be performed when approaching and/or travelling the downhill road section 310. Preferably, the distance to the approaching downhill road section 310 should not be too short as to risk non-optimal driving conditions of the first vehicle in the subsequent road section. On the other hand, the prediction does not need to be performed when the distance to the approaching downhill road section is too long. When the distance to the approaching downhill road section is too long, the expected speed of the second vehicle 300, and thus the expected distance to the second vehicle 300 when approaching and/or travelling the downhill road section 310, is difficult to predict and may be unreliable. Such unreliable prediction may not be suitable to use as basis for reliable and safe control the speed of the first vehicle 100. The prediction of the distance profiles may, according to a non-limiting example, be performed when the distance to the approaching downhill road section is between 200 and 800 meters according to an exemplifying implementation of the invention. The prediction of the distance profiles may, according to a further embodiments be performed continuously when the first vehicle 100 is in motion and applied according to the invention when braking is required in the approaching road section as will be explained further on.

The minimum distance to the second vehicle 300 in each distance profile is associated with the brake power for which the distance profile has been predicted. The brake power may, depending on implementation of the method 200, be a brake power applied by one of the plurality of brake systems 102, 104, 106, or a brake power constituting a sum of the brake power levels provided by a plurality of the brake systems 102, 104, 106. The brake power may for example correspond to a maximum power level deliverable by one of more of the plurality of brake systems 102, 104, 106 or a percentage of a maximum power level deliverable by one of more of the plurality of brake systems 102, 104, 106, as will be explained in more detail below.

For example, the brake power P_{brake_4} applied during simulation of the distance profile d in FIG. 5 represents the least efficient brake power from the brake powers P_{brake_1}, P_{brake_2}, P_{brake_3}, P_{brake_4} in FIG. 5, and may e.g., correspond to the braking force acting on the first vehicle 100 when driving in an ecoroll mode i.e., when rolling in neutral gear. P_{brake_3} applied during simulation of the distance profile c represents a brake power higher, or more efficient than P_{brake_4} and may correspond to the brake force acting on the first vehicle 100 in coasting mode, i.e., when rolling with current gear engaged. P_{brake_2} applied during simulation of the distance profile b represents a brake power higher, or more efficient than P_{brake_3} and P_{brake_4} and may be a brake power applied by e.g., regenerative braking. P_{brake_1} applied during simulation of the distance profile a represents the highest brake power from the brake powers P_{brake_1}, P_{brake_2}, P_{brake_3}, P_{brake_4} in FIG. 5, and may be a brake power applied by e.g., regenerative braking in combination with another auxiliary brake system such as e.g., exhaust brake at a downshifted gear. The prediction of minimum distance D_{min_4} by predictively applying P_{brake_4} by means of ecoroll may be used to determine if braking is required when approaching and/or travelling the downhill road section 310 as will be explained further on. The predictions of the other minimum distances D_{min_2}, D_{min_3}, D_{min_4} may be done to determine which brake power to apply when approaching and/or travelling the downhill road section 310.

Predicting a distance profile for an approaching road section may be done according to conventional methods. Examples of factors that may typically be considered in such prediction, in addition to geographical and topographical data relating to the approaching road section, include current speed of the first and the second vehicle, expected speed of the second vehicle in the approaching road section, vehicle configuration, vehicle load etc. Such factors may be obtained according to conventional methods. Advanced prediction methods may also take into consideration additional factors, such as weather conditions and current speed limitations for the approaching road section.

When the plurality of distance profiles has been predicted, the method 200 selects a brake power from the plurality of predicted distance profiles at least partly based on the minimum distance to the second vehicle, i.e., D_{min_1}, D_{min_2}, D_{min_3}, D_{min_4} in FIG. 5, and on the predetermined minimum distance D_{pred_min}. As previously described, the brake power may be selected to correspond to the brake power to be applied to obtain the minimum distance fulfilling the condition of being equal to or larger than the predetermined minimum distance D_{pred_min}. In that way, when the selected brake force is applied at least the predetermined minimum distance D_{pred_min} to the second vehicle 300 is maintained when approaching and/or travelling the downhill road section 310.

The predetermined minimum distance D_{pred_min} may be a distance selected by a vehicle operator or by a speed control system. As previously explained the predetermined minimum distance D_{pred_min} may be the smallest distance the first vehicle 100 is allowed to maintain to the second vehicle in front 300.

Thus, as illustrated in FIG. 5, the minimum distance D_{min_4} obtained by predictively applying the brake power P_{brake_4} is shorter than the predetermined minimum distance D_{pred_min}. In other words, the minimum distance D_{min_4} does not fulfill the condition of being equal to or larger that the predetermined minimum distance D_{pred_min}. However, the remaining minimum distances D_{min_1}, D_{min_2}, D_{min_3} obtained by predictively applying the respective brake powers P_{brake_1}, P_{brake_2}, P_{brake_3} are all larger than the predetermined minimum distance D_{pred_min} and fulfill thereby the condition of being equal to or larger that the predetermined minimum distance D_{pred_min}. This means that either one of the brake powers P_{brake_1}; P_{brake_2}; P_{brake_3} may be selected and applied by the method 200 in step 220 in FIG. 2.

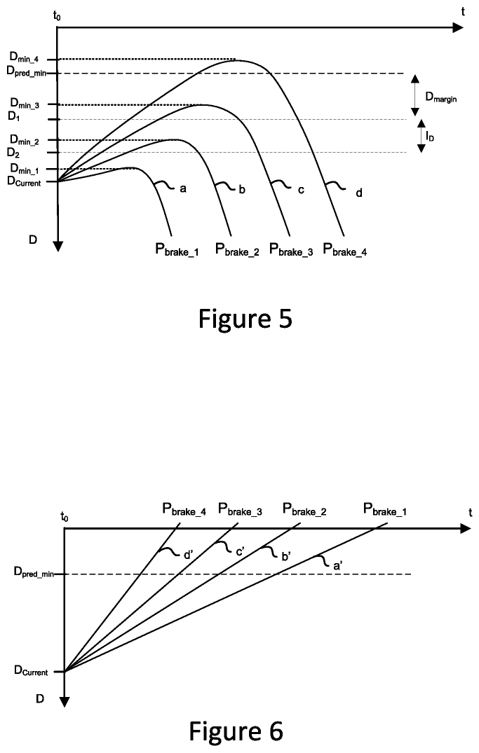

The method 200 according to FIG. 2 as well as further embodiments of the invention will now be explained more in detail with reference to FIG. 4. FIG. 4 discloses a flowchart of the method 200 comprising steps corresponding to the method steps 210-220 described with reference to FIG. 2 as well as further optional steps which may, in embodiments, be comprised in the method 200. It should be noted that the method steps illustrated in FIG. 4 and described herein do not necessarily have to be executed in the illustrated order. The steps may essentially be executed in any suitable order, as long as the physical requirements and the information needed to execute each method step is available when the step is executed.

In step I in FIG. 4, it is determined if a second vehicle 300 is present in front of the first vehicle 100. When it is determined that a second vehicle 300 is present in front of the first vehicle 100, the method continues to step II in FIG. 4, where it is determined if the first vehicle is approaching and/or travelling a downhill road section. Step I and step II may be performed according to conventional methods for example by means of the at least one sensor 140 in the first vehicle 100. Approaching and/or travelling a downhill road section may be e.g. determined based on map data, e.g. from digital maps containing topographical information, in combination with positioning information, e.g. GPS information. The positioning information may be used to determine the location of the vehicle relative to the map data so that a road gradient can be extracted from the map data. Various conventional cruise control systems use map data and positioning information. Such systems may then provide the map data and positioning information required for the method according to the present disclosure, thereby minimising the additional complexity involved in determining the road gradient.

When no downhill road section 310 is detected in front of the first vehicle 100, the method 200 returns to step I in FIG. 4 and remains in this loop until it is determined that a downhill road section is approaching.

In step III in FIG. 4, corresponding to step 210 in FIG. 2, a plurality of minimum distances D_{min_1}, D_{min_2}, . . . , D_{min_n} to the second vehicle 300 are predicted for an upcoming road section, when the first vehicle 100 approaches and/or travels the downhill road section 310 if braking at different brake powers P_{brake_1}, P_{brake_2} . . . , P_{brake_n} would currently be applied by at least one of the plurality of brake systems in the first vehicle 100 as described with reference to FIG. 2.

In an embodiment, each predicted minimum distance may correspond to a brake power to be applied when approaching and/or travelling the downhill road section 310 by one or more auxiliary brake systems. In that way, the distance to the second vehicle when braking is required is mainly controlled by means auxiliary brake systems thereby reducing the need of using friction brakes.

In an embodiment, the one or more auxiliary brake systems may be capable of applying a brake power at a plurality of brake power levels. Moreover, the one or more auxiliary brake systems utilized to apply the brake power may be applied at one of a plurality of brake power levels. The brake systems to be applied as well as their applied power levels when predicting the plurality of minimum distances D_{min_1}, D_{min_2}, . . . , D_{min_n} may depend on the implementation of the invention. In one example, a set of brake systems to be applied and their applied power levels when predicting the plurality of minimum distances D_{min_1}, D_{min_2}, D_{min_n} may be preconfigured in the control system of the first vehicle 100 and comprise brake systems that the particularly preferable and/or prioritized to apply when reducing the speed of the first vehicle 100.

In step IV in FIG. 4 it is determined if braking is required when approaching and/or travelling the downhill road section 310. As previously explained, such determining may be done based on the predicted minimum distance when the first vehicle 100 is driving in ecoroll mode. In other words, it may be determined that braking is required if the predicted minimum distance when travelling in ecoroll mode is smaller than the predetermined minimum distance D_{pred_min}, i.e., when the predetermined minimum distance D_{pred_min} cannot be maintained. Considering the predicted plurality of minimum distances D_{min_1}, D_{min_2}, D_{min_3}, D_{min_4} in FIG. 5a, where D_{min_4} is the predicted minimum distance when the vehicle travels in ecoroll mode, braking is required since D_{min_4} is smaller than D_{pred_min}. If braking is required, i.e., Yes in FIG. 4, the method 200 continues to step V. Otherwise, i.e., No in FIG. 4, the method 200 returns to step I in FIG. 4.

In step V in FIG. 4, it is determined if any of the minimum distances D_{min_1}, D_{min_2}, . . . , D_{min_n} predicted in step III fulfills the requirement of being equal or larger than a predetermined minimum distance D_{pred_min}. In other words it is determined if at least the predetermined minimum distance D_{pred_min} to the second vehicle 300 can be maintained when approaching and/or travelling the downhill road section 310 by applying one of the different brake powers P_{brake_1}, P_{brake_2}, . . . , P_{brake_n}.

When at least one predicted minimum distance equals or is larger than a predetermined minimum distance D_{pred_min}, i.e. Yes in FIG. 4, the method continues to step VI in FIG. 4. Otherwise, if No in FIG. 4, the method continues to step VII.

In step VI, corresponding to step 220 in FIG. 2, a brake power is applied as described with reference to FIG. 2. The applied brake power is one of the different brake powers P_{brake_1}, P_{brake_2}, . . . , P_{brake_n} which, when applied results in a minimum distance equal to or exceeding the predetermined minimum distance D_{pred_min}. In other words, the brake power is applied such that at least the predetermined minimum distance D_{pred_min} to the second vehicle 300 is maintained when approaching and/or travelling the downhill road section 310.

In an embodiment, the applied brake power may correspond to a brake power to be applied to obtain a minimum distance exceeding the predetermined minimum distance D_{pred_min}. The degree of which the predetermined minimum distance D_{pred_min} is to be exceeded may e.g., be defined by a distance D₁ exceeding the predetermined minimum distance. The distance D₁ may be longer compared to the predetermined minimum distance D_{pred_min} with the purpose of adjusting the vehicle's braking distance to the condition of travelling downhill thereby obtaining an increased driving and braking safety. Moreover, the distance D₁ may be defined such that when D₁ is maintained or exceeded when approaching and/or travelling the downhill road section 310, the need of using the friction brake system, such as wheel brakes is eliminated or at least reduced. Thus, the minimum distance D₁ may be defined such that it can be maintained or exceeded by means of at least one of the plurality of brake systems in the first vehicle 100 other than the friction brake system. Moreover, a longer distance to the second vehicle 300 in front when travelling in downhill enables energy efficient operation of the vehicle as will be explained further on with reference to step IX in FIG. 4. The distance D₁ exceeding the predetermined minimum distance D_{pred_min} may depend on parameters such as road gradient, the weight of the vehicle 100 and the vehicle speed to mention a few. The distance D₁ may for example be defined by a distance margin D_{margin} from the predetermined minimum distance D_{pred_min} as shown in FIG. 5, i.e., as an off-set value of the predetermined minimum distance D_{pred_min}. Thus, in the example illustrated in FIG. 5, D_{pred_min}+D_{margin}=D₁. As an example, a larger distance margin D_{margin_large} may be required on a steep downhill road section to avoid using the friction brake system compared to road sections with lower gradients, where a smaller distance margin D_{margin_small} may be used. In similar fashion a heavy vehicle may require a larger distance margin D_{margin_large} compared to a less heavy vehicle, where a smaller distance margin D_{margin_small} may be used. Furthermore, according to a non-limiting example, assuming D_{pred_min} being 50 m, the larger distance margin D_{margin_large} may for example be 15 m corresponding to D₁ being 65 m and the smaller distance margin D_{margin_small} may for example be 5 m corresponding to D₁ being 55 m. In the example illustrated in FIG. 5, both the predicted minimum distance D_{min_1} and the predicted minimum distance D_{min_2}, are larger than D₁. This means that by applying either one of the brake powers P_{brake_1}, P_{brake_2} at the time instance t₀ in step VI in FIG. 4, the minimum distance to the second vehicle will exceeded D₁.

In an embodiment, the applied brake power may correspond to the brake power to be applied to obtain a minimum distance within a predetermined distance interval ID. The predetermined distance interval I_{D} may be a distance interval of distances exceeding the predetermined minimum distance D_{pred_min}. Said predetermined distance interval I_{D} is, as illustrated in FIG. 5, defined by the above described shorter distance D₁ and a longer distance D₂, both D₁ and D₂ being larger than the minimum distance D_{pred_min}. In the example illustrated in FIG. 5 only the minimum distance D_{min_2}, obtained by predictively applying the brake power P_{brake_2}, is within the predetermined distance interval ID. Thus, based on the results of the predictions shown in FIG. 5, the brake power P_{brake_2} would be applied in step VI in FIG. 4.

The predetermined distance interval I_{D} may be predetermined such that the need of using the friction brake system, such as wheel brakes when approaching and/or travelling the downhill road section 310 is eliminated or at least reduced and at the same time such that using excessive brake power is avoided. In an embodiment, the predetermined distance interval I_{D} may be selected by an operator of the first vehicle 100. The predetermined distance interval I_{D} may for example be selected as an interval about a reference distance selected by the vehicle operator i.e., the average distance to the second vehicle 300 the operator wishes to be maintained. The predetermined distance interval I_{D} may be selected for the driving scenario of approaching and/or travelling in a downhill road section. In another example, the predetermined distance interval I_{D} may be set automatically in the vehicle's automatic speed control systems when approaching and/or travelling the downhill road section 310. The predetermined distance interval I_{D} may, as described above, be selected based on parameters such as road gradient, the weight of the first vehicle 100 and the first vehicle speed to mention a few. As an example, a shorter distance interval I_{D} may be required on a steep downhill road section to avoid using the friction brake system compared to road sections with lower gradients. In similar fashion a heavy vehicle may require a shorter distance interval I_{D} compared to a less heavy vehicle.

In an embodiment, when more than one brake power from the different brake powers P_{brake_1}, P_{brake_2}, . . . , P_{brake_n} result in a predicted minimum distance at least corresponding to the predetermined minimum distance D_{pred_min}, the brake power to be applied in step VI in FIG. 4 may be selected further based on one or more parameters.

The brake power may, for example, be selected based on a predetermined priority of the plurality of brake systems. In other words, the plurality of brake systems in the first vehicle 100 may be given different priorities to optimize energy efficiency, braking efficiency, drivability aspects or user comfort, to mention a few and may depend on parameters like the characteristics of the brake system and the vehicle configuration. Consequently, the brake power applied in step VI in FIG. 4, may correspond to the brake power applied by the brake system or a combination of brake systems with the highest priority. The priority of the plurality of brake systems may be e.g., predetermined in a priority table and be available in the vehicle control system. Regenerative braking may, for example, have the highest priority when energy efficient driving is optimized when an energy storage in the first vehicle 100 have capacity to store the recovered braking energy. Otherwise, another brake system with other advantages, such as braking efficiency, may be selected. In similar fashion, when driver comfort is to be optimized, parameters such a reduced noise, smooth speed may impact the priority of the brake systems.

The brake power may be selected based on the magnitude of a brake power required for braking the first vehicle 100 when approaching and/or travelling the downhill road section 310. The required brake power may be determined according to conventional methods using e.g. Newton's laws of motion so that at least a predetermined minimum distance D_{pred_min} to the second vehicle 300 is maintained when approaching and/or travelling the downhill road section 310. In that way an appropriate brake power may be applied by means the one or more brake system which is able to deliver the required brake power.

Furthermore, the brake power may be selected based on a duration of the application of at least one of the plurality of brake systems to be engaged when approaching and/or travelling the downhill road section 310 to produce the brake power required for braking the first vehicle 100. By determining the duration of the application of a brake system, the suitability of using the brake system may be determined.

Furthermore, the brake power may be selected based on the power level of at least one of the plurality of brake systems to be engaged when approaching and/or travelling the downhill road section 310 to produce the brake power required for braking the first vehicle 100. By taking into consideration the power level of at least one of the plurality of brake systems to be engaged the suitability of using the brake system may be determined. The brake power may, for example, be selected such that the applied brake system is able to withstand the required power level during the braking operation.

In a further embodiment, the brake power may be selected based on an efficiency of at least one of the plurality of brake systems to be engaged when approaching and/or travelling the downhill road section 310 to produce the brake power required for braking the first vehicle 100. The efficiency of the brake system may be understood as the ability of braking and energy efficiency of the brakes. By taking into consideration the efficiency of the at least one of the plurality of brake systems to be engaged the suitability of using the brake system may be determined. The brake power may, for example be selected to optimize efficient braking of the vehicle 100.

In short, different brake systems may be associated with a predetermined priority. Merely as an illustrative and non-limiting example, the first vehicle 100 may comprise a retarder, a compression brake and an exhaust brake. These may then be associated with different priority, e.g. first use the exhaust brake, then if necessary add (or switch to) the retarder, then if necessary add (or switch to) the compression brake. Further in this illustrative and non-limiting example, each of these brake systems may be associated with different magnitude of brake power, which may or may not meet the magnitude of a brake power required for braking the first vehicle 100 when approaching and/or travelling the downhill road section 310. It may be that one of the brake systems alone is sufficient or it may be that a combination of brake systems may be required to meet the magnitude of a brake power required for braking the first vehicle 100 when approaching and/or travelling the downhill road section 310. Further in this illustrative and non-limiting example, the duration of the application of a brake system or brake systems may be a factor to take into calculation when determining the brake power applied, as well as the efficiency of such (a) brake system(s).

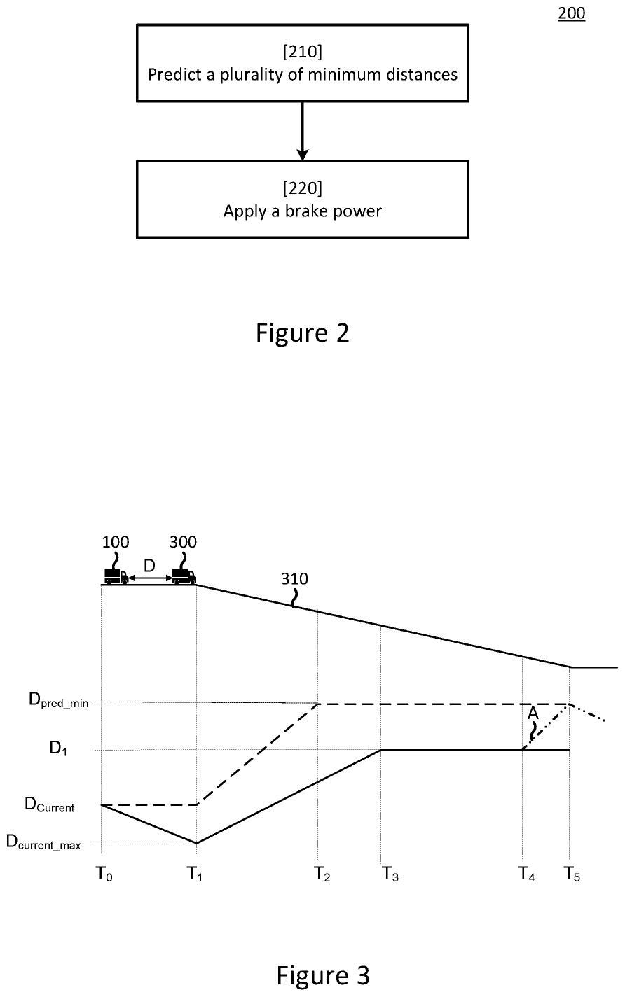

In step VII in FIG. 4, when it is determined that none of the plurality of minimum distances equals or exceeds the predetermined minimum distance D_{pred_min}, the highest brake power from the different brake powers P_{brake_1}, P_{brake_2} . . . , P_{brake_n} is applied by one or more auxiliary brake systems. Such situation is illustrated in FIG. 6.

FIG. 6 illustrates a non-limiting example of a result of predicting a plurality of minimum distances in a different driving situation compared to the example shown in FIG. 5. FIG. 6 shows, four predicted distance profiles a′, b′, c′, d′ corresponding to the different brake powers P_{brake_1}, P_{brake_2}, P_{brake_3}, P_{brake_4} to be applied at the time instance to. Here, the upcoming road section comprises a downhill road section which may be steeper than the downhill road section illustrated in FIG. 5. As a consequence, none of the predicted distance profiles a′, b′, c′, d′ comprises a minimum distance to the second vehicle 300 being equal to or larger than the predetermined minimum distance D_{pred_min}. In other words, none of the brake powers P_{brake_1}, P_{brake_2}, P_{brake_3}, P_{brake_4} is enough to brake the first vehicle 100 such that at least the predetermined minimum distance D_{pred_min} is maintained when approaching and/or travelling the downhill road section 310. Here, the braking of the first vehicle 100 may be done by applying the highest brake power i.e., P_{brake_1} in FIG. 6. The predetermined minimum distance D_{pred_min} may here be maintained according to conventional solutions, e.g., by applying an additional brake power by means of friction brakes.

In step VIII in FIG. 4 it is determined whether the end of the downhill road section is approaching. This may be done according to conventional method for example based on sensor data or map data as previously explained. When it is determined that the end of the downhill road section is approaching the method continues to step IX. Otherwise, the method returns to step III.

Thus, in embodiments, the plurality of minimum distances may be predicted repeatedly at different time instances when approaching and/or travelling the downhill road section 310. The prediction of minimum distances may, according to a non-limiting example be performed every second. Each prediction, at a specific time instance, may result in a plurality of updated minimum distances. Based on the updated minimum distances the applied brake power may be adjusted in step VI in FIG. 4 to correspond to an updated minimum distance of the plurality of updated minimum distances.

In step IX in FIG. 4, when it is determined that the first vehicle 100 approaches the end of the downhill road section 310 the applied brake power is reduced to reduce the distance to the second vehicle to a reduced distance. The reduced distance may at least correspond to the predetermined minimum distance D_{pred_min} as illustrated in FIG. 3 by the dashed line A between the time instance T₄ and T₅. In this way the speed of the first vehicle 100 increases which results in an increased speed at the end of the downhill road section 310. Thus, during the final part of the downhill road section 310, the vehicle gains kinetic energy, which can be used for the propulsions of the first vehicle 100 when the downhill road section has ended. By avoiding braking in the last part of the downhill, both time and energy is saved. This energy efficient operation of the first vehicle 100 is enabled by the method of the invention maintaining a distance to the second vehicle exceeding the predetermined minimum distance D_{pred_min} in downhill road section 310 as illustrated by the solid line in FIG. 3 between the time instance T₁ and T₄.

After step IX in FIG. 4, the method may be reverted back to step I.

According to an aspect of the invention, a control arrangement 120 for controlling a cruise controller of the first vehicle 100 is presented. The control arrangement 120 includes means 121 arranged predicting a plurality of minimum distances corresponding to different brake powers to be applied by at least one of the plurality of brake systems when approaching and/or travelling the downhill road section 310, each minimum distance constituting a resulting minimum distance to the second vehicle 300.

The control arrangement 120 further includes means 122 arranged for applying, by at least one of the plurality of brake systems, a brake power corresponding to a minimum distance of the plurality of minimum distances such that at least the predetermined minimum distance to the second vehicle 300 is maintained when approaching and/or travelling the downhill road section 310.

The control arrangement 120, e.g. a device or a control device, according to the invention may be arranged for performing all of the above, in the claims, and in the herein described embodiments method steps. The control arrangement 120 is hereby provided with the above-described advantages for each respective embodiment.

The invention is also related to a vehicle 100 including the control arrangement 120.

Now turning to FIG. 7 which illustrates the control arrangement 700/120, which may correspond to or may include one or more of the above-mentioned control units 121-122 i.e. the control units performing the method steps of the disclosed invention. The control arrangement 700/120 comprises a computing unit 701, which can be constituted by essentially any suitable type of processor or microcomputer, e.g. a circuit for digital signal processing such as Digital Signal Processor DSP, or a circuit having a predetermined specific function such as Application Specific Integrated Circuit ASIC. The computing unit 701 is connected to a memory unit 702 arranged in the control arrangement 700/120, which memory unit provides the computing unit 701 with, e.g., the stored program code and/or the stored data which the computing unit 701 requires to be able to perform computations. The computing unit 701 is also arranged to store partial or final results of computations in the memory unit 702.

In addition, the control arrangement 700/120 is provided with devices 711, 712, 713, 714 for receiving and transmitting input and output signals. These input and output signals can contain waveforms, impulses, or other attributes which, by the devices 711, 713 for the reception of input signals, can be detected as information and can be converted into signals which can be processed by the computing unit 701. These signals are then made available to the computing unit 701. The devices 712, 714 for the transmission of output signals are arranged to convert signals received from the computing unit 701 in order to create output signals by, e.g., modulating the signals, which can be transmitted to other parts of and/or systems in the vehicle 100.

Each of the connections to the devices for receiving and transmitting input and output signals can be constituted by one or more of a cable; a data bus, such as a Controller Area Network CAN bus, a Media Orientated Systems Transport MOST bus, or some other bus configuration; or by a wireless connection. A person skilled in the art will appreciate that the above-stated computer can be constituted by the computing unit 701 and that the above-stated memory can be constituted by the memory unit 702.

Control systems in modern vehicles commonly comprise communication bus systems consisting of one or more communication buses for linking a number of electronic control units ECUs, or controllers, and various components located on the vehicle. Such a control system can comprise a large number of control units and the responsibility for a specific function can be divided amongst more than one control unit. Vehicles of the shown type thus often comprise significantly more control units than are shown in FIG. 1 and FIG. 7 which is well known to the person skilled in the art within this technical field.

In a shown embodiment, the invention may be implemented by the one or more above mentioned control units 121 and 122. The invention can also, however, be implemented wholly or partially in one or more other control units already in the vehicle 100, or in some control unit dedicated to the invention.

Here and in this document, units are often described as being arranged for performing steps of the method according to the invention. This also includes that the units are designed to and/or configured to perform these method steps.

The one or more control units 121 and 122 are in FIG. 1 illustrated as separate units. These units may, however, be logically separated but physically implemented in the same unit or can be both logically and physically arranged together. These units may e.g. correspond to groups of instructions, which can be in the form of programming code, that are input into, and are utilized by a processor/computing unit 701 when the units are active and/or are utilized for performing its method step, respectively.

The person skilled in the art will appreciate that a the herein described embodiments may also be implemented in a computer program, which, when it is executed in a computer, instructs the computer to execute the method. The computer program is usually constituted by a computer program product 703 stored on a non-transitory/non-volatile digital storage medium, in which the computer program is incorporated in the computer-readable medium of the computer program product. The computer-readable medium comprises a suitable memory, such as, e.g.: Read-Only Memory ROM, Programmable Read-Only Memory PROM, Erasable Programmable Read-Only Memory EPROM, Flash memory, Electrically Erasable Programmable Read-Only Memory EEPROM, a hard disk unit, etc.

The invention is not limited to the above-described embodiments. Instead, the invention relates to, and encompasses all different embodiments being included within the scope of the independent claims.

1. Method performed by a control arrangement for controlling a speed of a first vehicle, the first vehicle comprising a plurality of brake systems configured to provide brake power for braking the vehicle, the method comprising, when a downhill road section is to be travelled, and when a second vehicle is travelling in front of the first vehicle:
predicting a plurality of minimum distances (D_{min_1}, D_{min_2}, . . . , D_{min_n}) corresponding to different brake powers (P_{brake_1}, P_{brake_2}, . . . , P_{brake_n}) to be applied by at least one of the plurality of brake systems when approaching and/or travelling the downhill road section, each minimum distance constituting a resulting minimum distance to the second vehicle, and
applying, by at least one of the plurality of brake systems, a brake power corresponding to the brake power to be applied to obtain the minimum distance of the plurality of minimum distances (D_{min_1}, D_{min_2}, . . . , D_{min_n}) such that at least a predetermined minimum distance (D_{pred_min}) to the second vehicle is maintained when approaching and/or travelling the downhill road section.

2. The method according to claim 1, wherein the applied brake power corresponds to the brake power to be applied to obtain the minimum distance exceeding the predetermined minimum distance (D_{pred_min}).

3. The method according to claim 1, wherein the applied brake power corresponds to the brake power to be applied to obtain the minimum distance being within a predetermined distance interval (I_{D}), the predetermined distance interval (I_{D}) being a distance interval of distances exceeding the predetermined minimum distance (D_{pred_min}).

4. The method according to claim 3, wherein the predetermined distance interval (I_{D}) is selected by an operator of the first vehicle.

5. The method according to claim 1, wherein each minimum distance (D_{min_1}, D_{min_2} . . . , D_{min_n}) corresponds to a brake power to be applied when approaching and/or travelling the downhill road section by one or more auxiliary brake systems.

6. The method according to claim 5, wherein the one or more auxiliary brake systems are capable of applying a brake power at a plurality of brake power levels and wherein the one or more auxiliary brake systems being utilized to apply the brake power are applied at one of a plurality of brake power levels.

7. The method according to claim 5, further comprising, when none of the plurality of minimum distances (D_{min_1}, D_{min_2}, . . . , D_{min_n}) equals or exceeds the predetermined minimum distance (D_{pred_min}),
applying, by the one or more auxiliary brake systems, a brake power corresponding to the highest brake power representing a minimum distance of the plurality of minimum distances (D_{min_1}, D_{min_2} . . . , D_{min_n})

8. The method according to claim 1, wherein the brake power being applied is selected at least partly based on at least one of:
a predetermined priority of the plurality of brake systems,
the magnitude of a brake power required for braking the first vehicle when approaching and/or travelling the downhill road section,
a duration of the application of at least one of the plurality of brake systems to be engaged when approaching and/or travelling the downhill road section to produce the brake power required for braking the first vehicle,
the power level of at least one of the plurality of brake systems to be engaged when approaching and/or travelling the downhill road section to produce the brake power required for braking the first vehicle, and/or
an efficiency of at least one of the plurality of brake systems to be engaged when approaching and/or travelling the downhill road section to produce the brake power required for braking the first vehicle.

9. The method according to claim 1, further comprising
repeatedly predicting the plurality of minimum distances (D_{min_1}, D_{min_2}, . . . , D_{min_n}) when approaching and/or travelling the downhill road section, each prediction resulting in a plurality of updated minimum distances, and based on the repeated predictions,
adjusting the applied brake power to correspond to the brake power to be applied to obtain the updated minimum distance of the plurality of updated minimum distances.

10. The method according to claim 1, further comprising when the first vehicle approaches the end of the downhill road section:
reducing the applied brake power to reduce the distance to the second vehicle to a reduced distance, the reduced distance at least corresponding to the predetermined minimum distance (D_{pred_min}).

11. A control arrangement for controlling a speed of a first vehicle (100), the first vehicle comprising a plurality of brake systems configured to provide brake power for braking the vehicle, the control arrangement being configured to, when a downhill road section (310) is to be travelled, and when a second vehicle is travelling in front of the first vehicle:
predict a plurality of minimum distances (D_{min_1}, D_{min_2}, . . . , D_{min_n}) corresponding to different brake powers (P_{brake_1}, P_{brake_2}, . . . , P_{brake_n}) to be applied by at least one of the plurality of brake systems when approaching and/or travelling the downhill road section, each minimum distance constituting a resulting minimum distance to the second vehicle, and
apply, by at least one of the plurality of brake systems, a brake power corresponding to the brake power to be applied to obtain the minimum distance of the plurality of minimum distances (D_{min_1}, D_{min_2} . . . , D_{min_n}) such that at least the predetermined minimum distance (D_{pred_min}) to the second vehicle is maintained when approaching and/or travelling the downhill road section.

12. A vehicle comprising a control arrangement according to claim 11.

13. A computer program comprising instructions which, when the program is executed by a computer, cause the computer to carry out the method according to claim 1.

14. A computer-readable medium comprising instructions which, when executed by a computer, cause the computer to carry out the method according to claim 1.
